(19) United States
(12) Patent Application Publication
(10) Pub. No.: US 2026/0222890 A1
(43) Pub. Date: Jul. 30, 2026

(54) RECEIVER CAPABILITY INFORMATION FOR AN INTERNET-OF-THINGS DEVICE

(71) Applicant: QUALCOMM INCORPORATED, San Diego, CA (US)

(72) Inventors: Luanxia YANG, Beijing (CN); Xiaojie WANG, Hillsborough, NJ (US); Xiaoxia ZHANG, San Diego, CA (US); Junyi LI, Greentown, PA (US)

(21) Appl. No.: 19/148,159

(22) PCT Filed: Mar. 6, 2023
(86) PCT No.: PCT/CN2023/079726

§ 371 Date: Jul. 15, 2025

(51) Int. Cl. H04W 28/02; H04L 67/12; H04L 69/24; H04W 8/24; H04W 28/18; H04W 72/1273; H04W 72/51

(52) U.S. Cl. CPC H04W 28/0215; H04L 67/12; H04L 69/24; H04W 8/24; H04W 28/18; H04W 72/1273; H04W 72/51

(57) ABSTRACT

Various aspects of the present disclosure generally relate to wireless communication. In some aspects, a user equipment (UE) may transmit an indication of receiver capability information associated with an Internet-of-Things (IoT) device. The UE may receive a signal that is based at least in part on the receiver capability information. In some aspects, the UE is the IoT device. Numerous other aspects are described.

### FIELD OF THE DISCLOSURE

Aspects of the present disclosure generally relate to wireless communication and to techniques and apparatuses for receiver capability information for an Internet-of-Things (IoT) device.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting an indication of receiver capability information associated with an Internet-of-Things (IoT) device. The method may include receiving a signal that is based at least in part on the receiver capability information. In some aspects, the UE is the IoT device.

Some aspects described herein relate to a method of wireless communication performed by a network node. The method may include receiving an indication of receiver capability information associated with an IoT device. The method may include transmitting a signal using a configuration that is based at least in part on the receiver capability information.

Some aspects described herein relate to an apparatus for wireless communication at a UE. The apparatus may include a memory and one or more processors coupled to the memory. The one or more processors may be configured to cause the UE to transmit an indication of receiver capability information associated with an IoT device. The one or more processors may be configured to cause the UE to receive a signal that is based at least in part on the receiver capability information. In some aspects, the UE is the IoT device.

Some aspects described herein relate to an apparatus for wireless communication at a network node. The apparatus may include a memory and one or more processors coupled to the memory. The one or more processors may be configured to cause the network node to receive an indication of receiver capability information associated with an IoT device. The one or more processors may be configured to cause the network node to transmit a signal using a configuration that is based at least in part on the receiver capability information.

Some aspects described herein relate to a non-transitory computer-readable medium that stores a set of instructions for wireless communication by a UE. The set of instructions, when executed by one or more processors of the UE, may cause the UE to transmit an indication of receiver capability information associated with an IoT device. The set of instructions, when executed by one or more processors of the UE, may cause the UE to receive a signal that is based at least in part on the receiver capability information. In some aspects, the UE is the IoT device.

Some aspects described herein relate to a non-transitory computer-readable medium that stores a set of instructions for wireless communication by a network node. The set of instructions, when executed by one or more processors of the network node, may cause the network node to receive an indication of receiver capability information associated with an IoT device. The set of instructions, when executed by one or more processors of the network node, may cause the network node to transmit a signal using a configuration that is based at least in part on the receiver capability information.

Some aspects described herein relate to an apparatus for wireless communication. The apparatus may include means for transmitting an indication of receiver capability information associated with an IoT device. The apparatus may include means for receiving a signal that is based at least in part on the receiver capability information.

Some aspects described herein relate to an apparatus for wireless communication. The apparatus may include means for receiving an indication of receiver capability information associated with an IoT device. The apparatus may include means for transmitting a signal using a configuration that is based at least in part on the receiver capability information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of an IoT device, in accordance with the present disclosure.

FIGS. 4A and 4B are diagrams illustrating examples of a first receiver block diagram and a second receiver block diagram, respectively, for processing simultaneous wireless information and power transfer (SWIPT), in accordance with the present disclosure.

FIG. 5 is a diagram illustrating an example of a wireless communication process between a network node and an IoT device, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Internet-of-Things (IoT) devices may be useful in a variety of applications for which battery replacement may be prohibitively difficult or undesirable. To illustrate, an IoT device may not include a battery and, instead, may harvest and/or accumulate energy from radio signaling. In some aspects, how a wireless communication system communicates with an IoT device may result in inefficient power harvesting by the IoT device. Further, each IoT device operating in a wireless network may have different receiver capabilities that additionally reduce an efficiency of power harvesting and/or information recovery by the IoT device. For example, without knowledge of the receiver capabilities that an IoT device includes, a network node may select a transmission configuration for an energy signal and/or a communication signal that results in increased recovery errors at the IoT device and/or inefficient power harvesting that fails to provide the IoT with power to operate.

Some techniques and apparatuses described herein provide receiver capability information for an IoT device. In some aspects, an IoT device may transmit an indication of receiver capability information associated with the IoT device. Based at least in part on transmitting the receiver capability information, the IoT device may receive a signal that is based at least in part on the receiver capability information. To illustrate, a network node may receive the indication of the receiver capability information associated with IoT device, and transmit the signal using a configuration that is based at least in part on the receiver capability information as described below.

By transmitting receiver capability information, an IoT device may indicate supported and unsupported features of the IoT device. A network node receiving the receiver capability information may subsequently modify a signal and/or transmission based at least in part on the receiver capability information as described above and below. The ability to modify the signal based at least in part on supported and/or unsupported features at the IoT device may result in fewer data recovery errors and/or increased a power harvesting efficiency at the IoT device.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

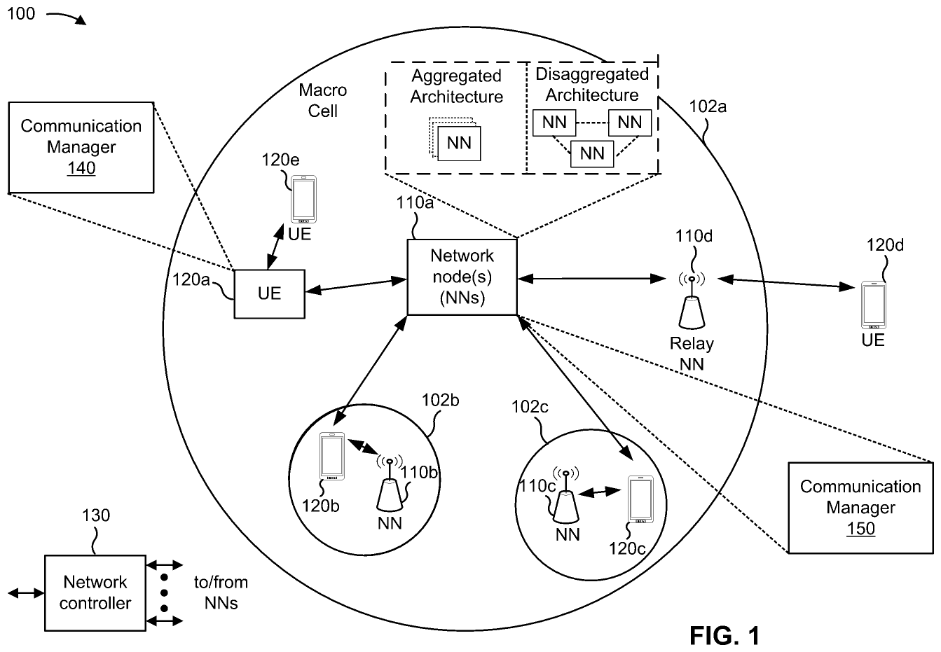

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, an IoT device described elsewhere herein may correspond to the UE 120. Additionally, or alternatively, the IoT device may include a communication manager 140.

In some aspects, a UE (e.g., the UE 120) may include a communication manager 140. As described in more detail elsewhere herein, the communication manager 140 may transmit an indication of receiver capability information associated with an IoT device; and receive a signal that is based at least in part on the receiver capability information. In some aspects, the UE is the IoT device. Additionally, or alternatively, the communication manager 140 may perform one or more other operations described herein.

In some aspects, a network node (e.g., the network node 110) may include a communication manager 150. As described in more detail elsewhere herein, the communication manager 150 may receive an indication of receiver capability information associated with an IoT device; and transmit a signal using a configuration that is based at least in part on the receiver capability information. Additionally, or alternatively, the communication manager 150 may perform one or more other operations described herein.

As indicated above, FIG. 1 is provided as an example. Other examples may differ from what is described with regard to FIG. 1.

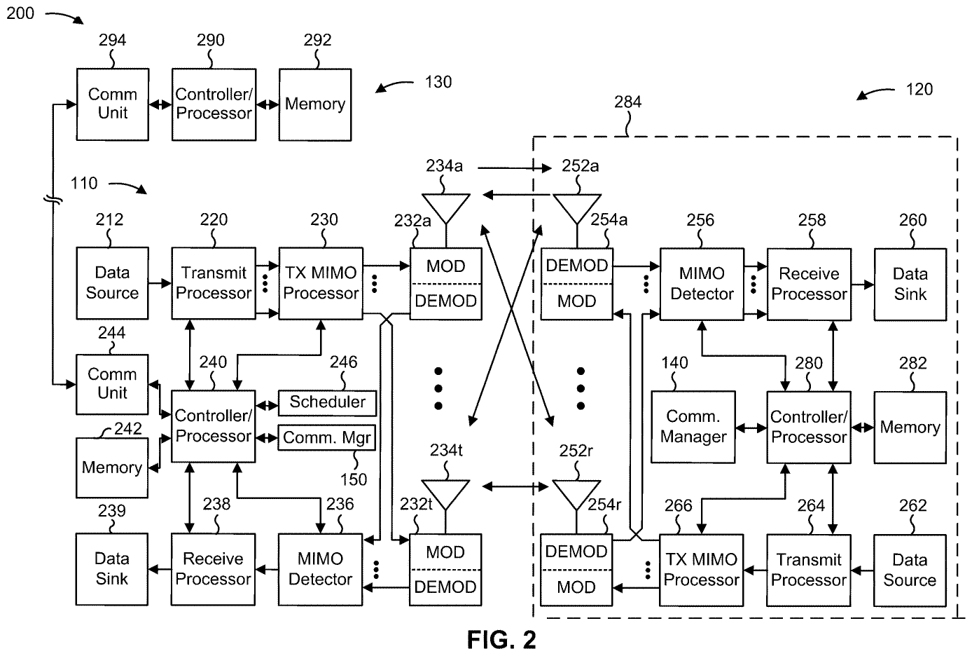

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

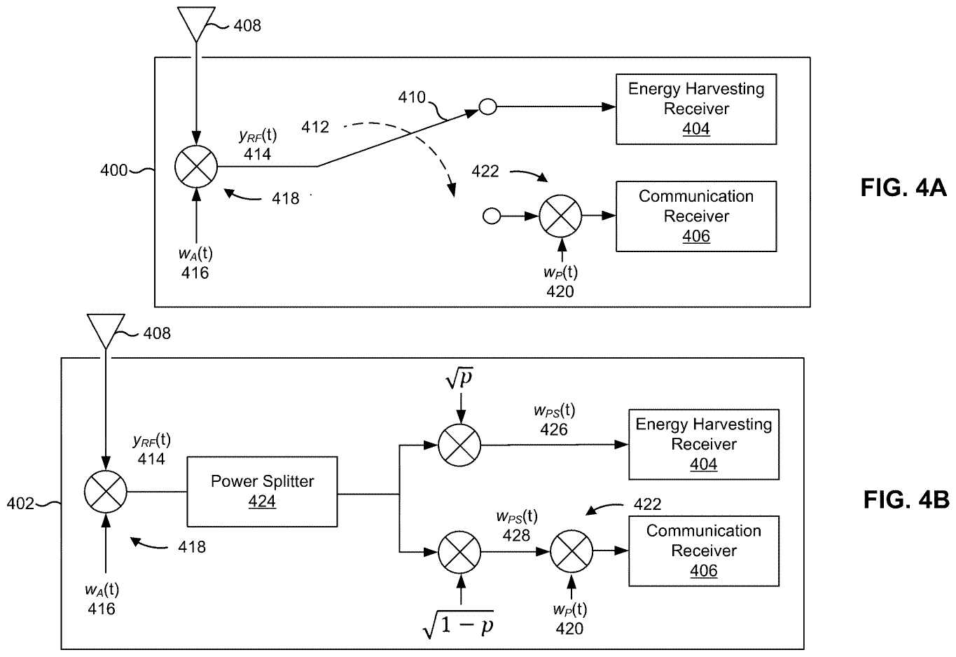

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-9).

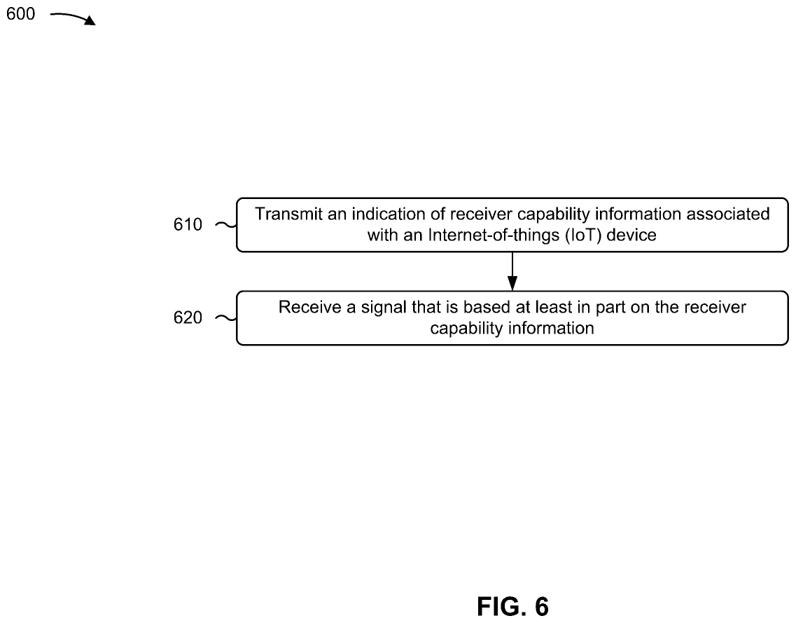

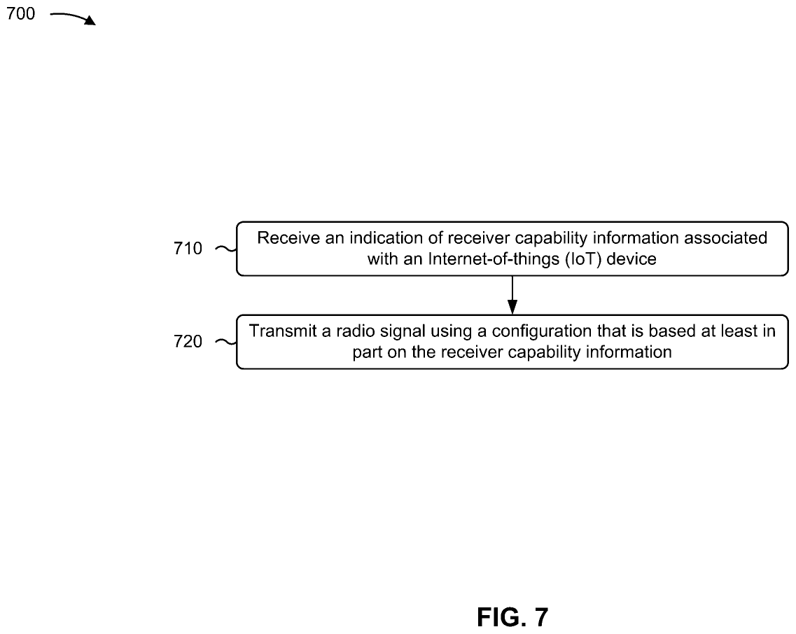

The controller/processor 240 of the network node 110, the controller/processor 280 of the UE 120, and/or any other component(s) of FIG. 2 may perform one or more techniques associated with receiver capability information for an IoT device, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting an indication of receiver capability information associated with an IoT device; and/or means for receiving a signal that is based at least in part on the receiver capability information. In some aspects, the UE is the IoT device. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving an indication of receiver capability information associated with an IoT device; and/or means for transmitting a signal using a configuration that is based at least in part on the receiver capability information. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

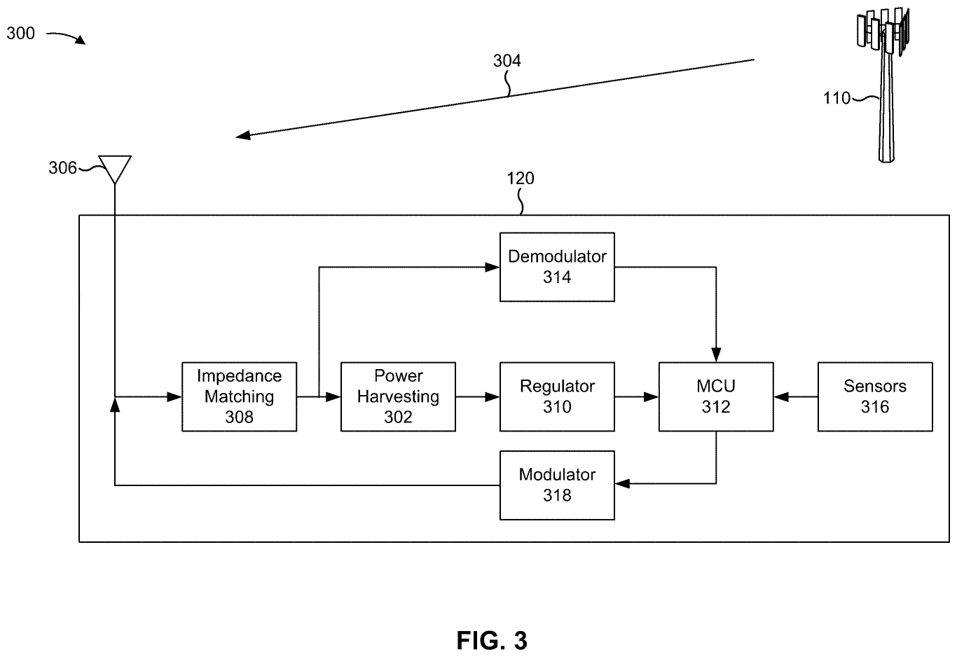

FIG. 3 is a diagram illustrating an example 300 of an IoT device, in accordance with the present disclosure.

Some wireless communication devices may be considered IoT devices, such as ambient IoT devices (sometimes referred to as ultra-light IoT devices), or similar IoT devices. IoT technology may include passive IoT (e.g., NR passive IoT for 5G Advanced), semi-passive IoT, ultra-light IoT, or ambient IoT, among other examples. In passive IoT, an IoT terminal device (e.g., a radio frequency identification (RFID) device, a tag, or a similar device) may not include a battery, and the terminal may accumulate energy from signaling. Additionally, the terminal may accumulate solar energy to supplement accumulated energy from signaling. In passive IoT, a communication distance may be up to 30 meters (or more) to facilitate feasible network coverage over a large area (e.g., 5000 square meters), such as in a warehouse. Moreover, the power consumption of a passive IoT terminal (e.g., a UE) may be less than 0.1 milliwatts (mW) to support operation without a battery, and the terminal may be relatively inexpensive to facilitate cost-sensitive uses. A positioning accuracy of a passive IoT terminal may be approximately 3-5 meters in the horizontal and the vertical directions.

Passive IoT may be useful in connection with industrial sensors, for which battery replacement may be prohibitively difficult or undesirable (e.g., for safety monitoring or fault detection in smart factories, infrastructures, or environments). Additionally, features of passive IoT devices, such as low cost, small size, maintenance-free, durable, long lifespan, or the like, may facilitate smart logistics/warehousing (e.g., in connection with automated asset management by replacing RFID tags). Furthermore, passive IoT may be useful in connection with smart home networks for household item management, wearable devices (e.g., wearable devices for medical monitoring for which patients do not need to replace batteries), and/or environment monitoring. To achieve further cost reduction and zero-power communication, 5G+/6G wireless networks may utilize a type of passive IoT device referred to as an “ambient backscatter device” or a “backscatter device.”

Some IoT devices may be referred to as semi-passive IoT devices, because communication between a reader and the IoT device does not need to be preceded by an energy harvesting waveform. For example, semi-passive IoT devices may include a battery or similar energy source that can power the receiver and/or logic circuit. For such devices, energy harvesting may still be triggered in some cases, such as for long-range communications. In such examples, a rectifier circuit of the IoT device may have a warm start from the battery or other energy source, and thus may be associated with a lower minimum received power requirement than passive IoT devices (e.g., −30 dBm rather than −20 dBm). Nonetheless, long-range communications may require battery power spend to energize each decoding. More particularly, for long-range communications in which an energy harvesting rate is lower than a decoding circuit requirement, such as when the energy harvesting rate is below −30 dBm, the semi-passive IoT device may expend battery power to energize each decoding. Thus, continuous IoT device monitoring, such as for purposes of receiving a long-distance query communication, may result in excessive battery drain at the IoT device.

In that regard, passive and semi-passive IoT devices may be inherently limited for certain applications. For example, passive IoT devices, such as a backscatter device, may be associated with a low cost and form factor because there is no need for an RF chain at the IoT device. However, passive IoT devices may use an energy harvesting waveform as an only power source, which may limit the application of such passive IoT devices to short-distance communications. Although semi-passive IoT devices may eliminate the need for an energy harvesting waveform and/or may enable long-distance communications, such devices increase cost and complexity because the devices require the use of a battery or similar energy source. Moreover, because passive and semi-passive devices may be associated with a communication session that is initiated by the RF source, these devices may be inherently limited for use in sensing scenarios or similar latency-critical applications that require aperiodic traffic, and the devices may not scale well for use in high IoT density applications.

In some cases, an ambient IoT device (sometimes referred to as an ultra-light IoT device) may be employed. An ambient IoT device may be a device that is capable of transmitting an uplink trigger, and thus may initiate a communication session from the IoT device side. For example, an ambient IoT device may be associated with uplink transmissions that do not utilize a power amplifier (e.g., a transmission in the range of 0 to 5 dBm), and for which there is limited transmission capability, such as an ability to simply transmit a preamble transmission to indicate uplink traffic. In some aspects, an ambient IoT device may be implemented as a passive IoT device and/or a semi-passive IoT device.

The example 300 includes a network entity and/or network node (e.g., network node 110) and a UE 120 that may be implemented at least in part as a passive IoT device, a semi-passive IoT device, and/or an ambient IoT device. The UE 120 includes a power harvesting component 302 that includes an electronic circuit to convert energy from an input signal 304 (e.g., a downlink signal from the network entity) received via an antenna 306 to an energy source for one or more components included in the UE 120. In some aspects, and as described with regard to FIGS. 4A and 4B, the network node 110 may transmit, as the input signal 304, multiple signals, such as a first signal configured as an energy signal for power harvesting by the UE 120 and a second signal configured as a communication signal that carries information and/or data directed to the UE 120.

In some aspects, the power harvesting component 302 may include a diode that is electrically coupled to a capacitor. The power harvesting component 302 may receive the input signal 304 based at least in part on an antenna 306 and/or an impedance matching circuit 308. As shown by the example 300, the power harvesting component 302 may electrically couple to a regulator component 310 that outputs a fixed voltage for powering a microcontroller unit (MCU) 312. As one example, the regulator component 310 may convert an input alternating current (AC) signal to a direct current (DC) signal. The MCU 312 may process input from a demodulator component 314 (e.g., that demodulates the input signal 304) and/or one or more sensors 316. In some aspects, the MCU 312 may generate an output that is input to a modulator component 318 and transmitted by the UE 120 to the network node 110. While the example 300 shows the UE 120 as including a demodulator component 314 and a modulator component 318, other examples of a passive UE may not include the demodulator component 314 and/or the modulator component 318. For example, a passive UE implemented as a passive IoT device and/or a passive RFID tag may include a diode, a capacitor, a resistor, and a switch to generate a backscatter signal (e.g., a reflected signal) that includes modulated information.

As indicated above, FIG. 3 is provided as an example. Other examples may differ from what is described with regard to FIG. 3.

FIGS. 4A and 4B are diagrams illustrating examples of a first receiver block diagram 400 and a second receiver block diagram 402, respectively, for processing simultaneous wireless information and power transfer (SWIPT), in accordance with the present disclosure.

In some aspects, how a wireless communication system (e.g., a 5G wireless communication system) communicates with an IoT device (e.g., a passive IoT device, a semi-passive IoT device, and/or an ambient IoT device) may result in inefficient power harvesting by the IoT device. To illustrate, a power associated with an output signal by a power harvester component included in the IoT device may be based at least in part on diode behavior that is relative to characteristics associated with an input signal. For example, for a first range of input voltages and/or signals, the diode may output a first output signal with higher power relative to a second output signal that is associated with a second range of input voltages and/or signals. Accordingly, an output signal (and/or a power level associated with the output signal) may vary based at least in part on a diode and the diode's operating characteristics. As another example, power harvesting by an IoT device may be configured to work when operating 10 meters or less from a network entity based at least in part on a link budget. That is, the device may successfully capture power from an environment based at least in part on operating within 10 meters of the transmitting device, and may be inoperative outside that operating range.

“Simultaneous wireless information and power transfer” (SWIPT) may denote contemporaneous transmission of at least two signals: a communication signal and an energy signal. As one non-limiting example, a transmitting device, such as the network node 110, may modulate information and/or data on the communication signal, and may transmit the energy signal as a carrier wave without any modulated information and/or data. An energy signal transmitter and a communication signal transmitter may be co-located at a same device (e.g., the network node 110). A receiving device, such as an IoT device, may process the communication signal and the energy signal differently based at least in part on a usage associated with each signal. For instance, the communication signal may be processed by a demodulator (e.g., the demodulator component 314) for recovering information and not processed by a power harvester (e.g., the power harvesting component 302). Alternatively, or additionally, the energy signal may be processed by the power harvester to recover power and not the demodulator. Accordingly, the receiving device may include a communication receiver that may include any combination of hardware, software, and/or firmware for processing the communication signal (e.g., demodulating and/or decoding the information) and an energy harvesting receiver that may be any combination of hardware, software, and/or firmware for processing the energy signal (e.g., to harvest power). In some aspects, the communication receiver and the energy harvesting receiver may be co-located and/or integrated into a common receiver, while in other aspects, the communication receiver and the energy harvesting receiver may be separate from one another.

The first receiver block diagram 400 shown by FIG. 4A provides an example of an energy harvesting receiver 404 and a communication receiver 406 time-sharing access to an antenna 408. To illustrate, the energy harvesting receiver 404 may include the power harvesting components 302 and/or the regulator component 310 described with regard to FIG. 3. Alternatively or additionally, the communication receiver 406 may include the demodulator component 314 and/or the MCU 312 described with regard to FIG. 3. The first receiver block diagram 400 may include alternate or additional components that are not shown by FIG. 4A for visual brevity, such as any combination of components shown and described with regard to FIG. 3. The energy harvesting receiver 404 and the communication receiver 406 may be operatively coupled to an antenna 408 based at least in part on a switch 410, such as a transistor and/or an RF switch.

In some aspects, the switch 410 may alternate between coupling the energy harvesting receiver 404 to the antenna 408 and coupling the communication receiver 406 to the antenna 408. For example, the switch 410 may couple the energy harvesting receiver 404 to the antenna 408 during a first time span (e.g., 10 milliseconds (msec), 10 microseconds (usec), 21 μsec, and/or 1.4 msec). At the expiration of the first time span, the switch 410 may alternate positions as shown by reference number 412 to decouple the energy harvesting receiver 404 from the antenna 408 and couple the communication receiver 406 to the antenna 408. The switch 410 may couple the communication receiver 406 to the antenna 408 during a second time span and, at expiration of the second time span, decouple the communication receiver 406 from the antenna 408 and couple the energy harvesting receiver 404 to the antenna 408. The switch 410 may iteratively and/or periodically repeat the coupling and decoupling as described above. The first time span and the second time span may have a same duration or different durations from one another. That is, the energy harvesting receiver 404 and the communication receiver may be coupled to the antenna 408 for a same amount of time or different amounts of time.

During the first time span, the energy harvesting receiver 404 may receive a signal 414 (shown as y_{RF}(t)) that may be based at least in part on an RF signal received by the antenna 408. As one example, and as shown by FIG. 4A, the signal 414 may be based at least in part on the antenna 408 converting the RF signal to an electrical signal that is down-converted and/or mixed with a first mixing signal 416 based at least in part on a first mixer 418 to generate the signal 414. To illustrate, the RF signal received by the antenna 408 (e.g., an energy signal and a communication signal) may be in the above 6 GHz range, and the signal 414 may be mixed to an intermediate frequency (IF) at a lower frequency (e.g., 100 MHz). Accordingly, and during the first time span, the energy harvesting receiver 404 may receive the signal 414 based at least in part on the switch 410 coupling the energy harvesting receiver 404 to the antenna 408.

During the second time span, the signal 414 may be additionally mixed with a second mixing signal 420 (shown as y_{P}(t)) based at least in part on a second mixer 422. To illustrate, the signal 414 may be mixed with the second mixing signal 420 to generate a baseband signal and/or a baseband version of the signal 414 that is input to the communication receiver 406. However, in other examples, the communication receiver 406 may receive the signal 414 and without the additional mixing.

The first receiver block diagram 400 provides an example of a time splitting receiver architecture in which the energy harvesting receiver 404 and the communication receiver 406 share and alternate access to the antenna 408 and, subsequently, the signal 414. While the first receiver block diagram 400 includes the first mixing signal 416, the first mixer 418, the second mixing signal 420, and the second mixer 422, other examples may exclude one or more of these aspects. An IoT device that includes a time splitting receiver architecture as described above may harvest energy and recover information (e.g., demodulate and/or decode information) at different times and/or based at least in part on time division multiplexing.

The second receiver block diagram 402 shown by FIG. 4B provides an example of a power splitting receiver architecture. In the second receiver block diagram 402, the energy harvesting receiver 404 and the communication receiver 406 share contemporaneous and/or simultaneous access to the antenna 408 based at least in part on a power splitter 424. Thus, an IoT device that includes a power splitting receiver architecture may harvest energy and recover information concurrently.

In some aspects, a power splitter may be a device, circuit, and/or component that receives an input signal and generates multiple output signals that each have a respective amplitude and/or respective phase. To illustrate, a passive power splitter may include multiple resistors, and each output signal may be based at least in part on a voltage difference across a respective resistor. In the second receiver block diagram 402, the power splitter 424 generates two output signals, but other example power splitters may generate more output signals. The power splitter 424 may be implemented with a fixed power splitting ratio for generating the two output signals or may be implemented with a tunable power splitting ratio. The output signals may be output with equal and/or commensurate (e.g., within a range of values and/or within a threshold) power levels or may be output with different power levels.

To illustrate, the signal 414 may have a normalized power level of “1”, and the power splitter 424 may generate a first power split signal 426 and a second power split signal 428 that each have a respective power level that is a portion of the normalized power level of signal 414. For example, and as shown by FIG. 4B, the first power split signal 426 may have a power level of p and an amplitude of \sqrt{p}, where p is a value that ranges from 0-1, and the second power split signal 428 may have a power level of 1−p and an amplitude of \sqrt{1−p}. Accordingly, the energy harvesting receiver 404 may receive the first power split signal 426 as input and the communication receiver 406 may receive the second power split signal 428 (and/or a baseband version of the second power split signal 428) as input.

Although SWIPT may help mitigate power harvesting inefficiencies of an IoT device (e.g., an ambient IoT and/or passive IoT), each IoT device operating in a wireless network may have different receiver capabilities that reduce an efficiency of power harvesting and/or information recovery by the IoT device. For instance, a first IoT device may only support envelope detection, a second IoT device may support in-phase/quadrature (IQ) demodulation, a third IoT may have receiver capabilities to only receive a wideband signal, a fourth IoT device may have receiver capabilities to only receive a narrowband signal, a fifth IoT device may include a time-splitting receiver architecture (e.g., the first receiver block diagram 400), and/or a sixth IoT device may include a power splitting receiver architecture (e.g., the second receiver block diagram 402). Without knowledge of the receiver capabilities an IoT device includes, a network node may select a transmission configuration for an energy signal and/or a communication signal that results in increased recovery errors at the IoT device and/or inefficient power harvesting that fails to provide the IoT with power to operate.

Some techniques and apparatuses described herein provide receiver capability information for an IoT device. In some aspects, an IoT device may transmit an indication of receiver capability information associated with the IoT device. To illustrate, the receiver capability information may indicate a receiver architecture (e.g., a time splitting receiver architecture or a power splitting receiver architecture), one or more supported modulation formats, support for frequency division multiplexing (FDM) and/or support for SWIPT. The IoT device may transmit the indication of the receiver capability information in a variety of ways, such as by transmitting the indication in backscatter, transmitting the indication based at least in part on receiving a request for the receiver capability information, and/or autonomously (e.g., in a broadcast message and/or in a unicast message). Based at least in part on transmitting the receiver capability information, the IoT device may receive a signal that is based at least in part on the receiver capability information. To illustrate, the signal may include information via a modulation format that the receiver capability information indicates the IoT device supports. Alternatively, or additionally, the signal may have a received power level that is based at least in part on a power ratio of a power splitter that feeds into an energy harvesting receiver and a communication receiver. In some aspects, the signal may alternate between an energy signal and a communication signal. Accordingly, a network node may receive the indication of the receiver capability information associated with IoT device, and transmit the signal using a configuration (e.g., a power level, a modulation format, a signal type (e.g., an energy signal or an information), and/or a time-splitting configuration) that is based at least in part on the receiver capability information.

By transmitting receiver capability information, an IoT device may indicate supported and unsupported features of the IoT device. A network node receiving the receiver capability information may subsequently modify a signal and/or transmission based at least in part on the receiver capability information as described above and below. The ability to modify the signal based at least in part on supported and/or unsupported features at the IoT device may result in fewer data recovery errors and/or increased a power harvesting efficiency at the IoT device.

As indicated above, FIGS. 4A and 4B are provided as examples. Other examples may differ from what is described with regard to FIGS. 4A and 4B.

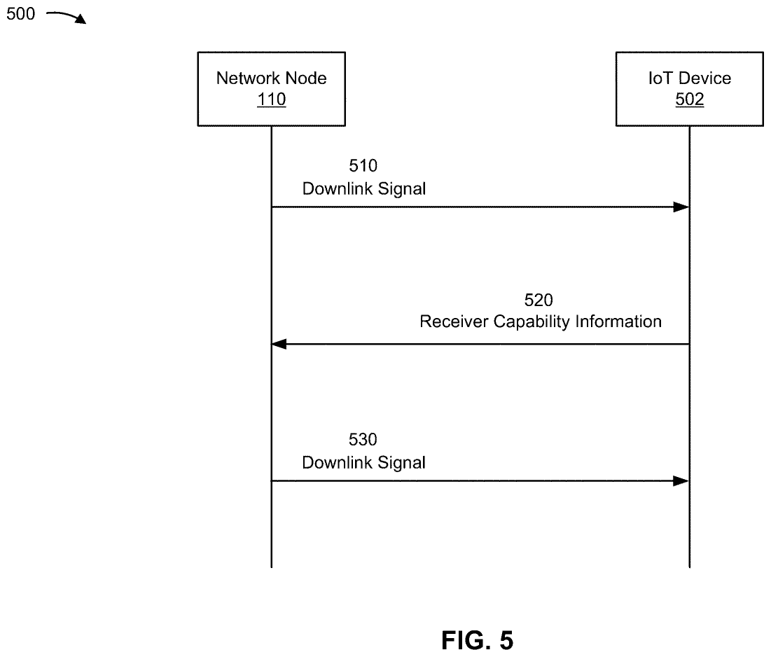

FIG. 5 is a diagram illustrating an example 500 of a wireless communication process between a network node (e.g., the network node 110) and an IoT device 502 (e.g., a UE 120), in accordance with the present disclosure.

As shown by reference number 510, a network node 110 may transmit, and an IoT device 502 may receive, a first downlink signal. As one example, the first downlink signal may include and/or indicate a request for the receiver capability information. As yet another example, the first downlink signal may be an energy signal configured to provide the IoT device 502 with energy for powering up. However, while the example 500 includes the network node 110 transmitting a first downlink signal received by the IoT device 502, the network node 110 may not transmit the first downlink signal to the IoT device 502 in other examples. Further, although FIG. 5 illustrates a single signaling transmission from the network node 110 to the IoT device 502, other examples may include multiple transmissions between the network node 110 and the IoT device 502

To illustrate, the network node 110 may initiate a communication session (sometimes referred to as a query-response communication) with a query, which may be a modulating envelope of a carrier wave (CW). The IoT device 502 may respond by backscattering the CW. The communication session may include multiple rounds, such as for purposes of contention resolution when multiple backscatter devices respond to a query. The IoT device 502 may have reflection-on periods and reflection-off periods that follow a pattern that is based at least in part on the transmission of information bits by the IoT device 502. The network node 110 may detect the reflection pattern of the IoT device 502 and obtain a backscatter communication that includes information. To illustrate, the IoT device 502 may use an information modulation scheme, such as amplitude shift keying (ASK) modulation (e.g., on-off keying (OOK) modulation). For ASK and/or OOK modulation, the IoT device 502 may switch on reflection when transmitting an information bit “1” and switch off reflection when transmitting an information bit “0.”

As shown by reference number 520, the IoT device 502 may transmit, and the network node 110 may receive, an indication of receiver capability information. In some aspects, the IoT device 502 may transmit the receiver capability information based at least in part on receiving the first downlink signal from the network node 110. For example, the IoT device 502 may transmit the indication of the receiver capability information in backscatter using the first downlink signal. As another example, the first downlink signal may include and/or indicate a request for the receiver capability information, and the IoT device 502 may transmit the receiver capability information in response to receiving the request. As yet another example, the IoT device 502 may harvest energy from the first downlink signal and, based at least in part on harvesting energy that satisfies a power level threshold and enables operation of the IoT device 502, the IoT device 502 may transmit the receiver capability information as part of a turn-on sequence or as part of an unfinished sequence from powering down at a prior point in time. However, in other examples, the IoT device 502 may transmit the receiver capability information autonomously, such as by broadcasting the receiver capability information periodically and/or after a time span of powering on.

The receiver capability information may indicate one or more receiver capabilities, such as a receiver architecture, a supported modulation and/or demodulation type, a supported signal format (e.g., SWIPT), and/or configuration details as described below. As one example, the IoT device 502 may indicate a time splitting capability and/or a time splitting receiver architecture (e.g., the first receiver block diagram 400). Alternatively or additionally, the IoT device 502 may indicate one or more switching time periods, such as a first switching time period that is associated with a first transition from receiving a signal using an energy harvesting receiver to receiving a signal using a communication receiver and/or a second switching time period that is associated with a second transition from receiving the signal using the communication receiver to receiving the signal using the energy harvesting receiver. In some aspects, the first switching time period may be different from and/or asymmetric with the second switching time period. To illustrate, the energy harvesting receiver and the communication receiver may include different electronic circuits, RF components, filtering specifications, filtering lengths, and/or interference rejection specifications relative to one another. Accordingly, the first switching time period and the second time switching period may be different from one another based at least in part on the different circuits, filtering specifications, and/or rejection specifications.

In some aspects, the receiver capability information may specify a switching time period based at least in part on one or more signal characteristics. For example, the receiver capability information may specify, for the first transition and/or the second transition, a respective switching time period that is based at least in part on an energy signal and a communication signal having a same carrier frequency and/or being located in a same bandwidth part (BWP). Alternatively, or additionally, the receiver capability information may specify, for the first transition and/or the second transition, a respective switching time period that is based at least in part on the energy signal and the communication signal having different carrier frequencies and/or being located in different BWPs. To illustrate, switching time periods that are associated with an energy signal that is FDM-ed with a communication signal may include an RF retuning time that is based at least in part on filtering specifications, and/or rejection specifications of a receiver. For example, for FDM-ed signals, a switching time period that is associated with the first transition from the energy harvesting receiver to the communication receiver may include a retuning settling time and/or hardware settling time to enable the IoT device 502 to recover information and/or reduce recovery errors that may be due to settling distortion in a received signal. However, the second transition from the communication receiver to the energy harvesting receiver may exclude a retuning settling time and/or a hardware settling time based at least in part on the energy harvesting receiver having fewer settling requirements and/or less sensitively to settling distortion relative to the communication receiver. That is, the energy harvesting receiver may be able to harvest energy from the receive signal without waiting for a same amount of settling used by the communication receiver to reduce recovery errors. Accordingly, the second settling time period may be shorter than the first settling time period.

In some aspects, the first switching time period and/or the second switching time period may be provisioned to the IoT device 502. For example, the network node 110 may transmit an indication of the first switching time period and/or the second time period to the IoT device 502 in the first downlink signal described with regard to reference number 510, and the IoT device 502 may apply and/or use these switching time periods to alternate coupling an energy harvesting receiver and a communication receiver to an antenna as described above. Alternatively, or additionally, the network node 110 may provision multiple different IoT devices with different switching time values to manage, coordinate, and/or control how the multiple IoT devices respond to a downlink SWIPT. To illustrate, different IoT devices may have different switching times from one another. In some aspects, the network node 110 may group IoT devices based at least in part on respective switching times, such as by grouping IoT devices with commensurate switching times (e.g., with switching times that are within a range of values and/or within a threshold). The network node 110 may transmit an energy signal and/or a communication signal to the group of IoT devices based at least in part on the switching times. For instance, the network node 110 may configure the transmission of an energy signal and/or communication signal based at least in part on a time division multiplexing (TDM) configuration and the commensurate switching times, and transmit the energy signal and/or communication to the group of IoT devices. The ability transmit the same transmission to the group of IoT devices simplifies processing at the network node 110 by reducing a number of transmission configurations and/or enabling the use of a same transmission configuration for multiple IoT devices.

The IoT device 502 may indicate, in the receiver capability information, a power splitting capability and/or a power splitting receiver architecture (e.g., the second receiver block diagram 402). Alternatively, or additionally, the receiver capability information may indicate one or more power splitting parameters. As one example, the receiver capability information may specify a power split ratio of how a receive signal is split between an energy harvesting receiver and a communication receiver. Alternatively or additionally, the receiver capability information may indicate whether the power split ratio is a fixed ratio or is a tunable ratio. That is, the receiver capability information may specify that the IoT device 502 includes power ratio tuning capabilities.

The IoT device 502 may indicate, via the receiver capability information, a preconfigured and/or predefined power splitting ratio. A preconfigured power splitting ratio may be a power-splitting ratio that has a shared and/or common definition between at least two devices. To illustrate, the network node 110 and the IoT device 502 may agree upon a set of preconfigured power splitting ratios by utilizing a common look-up table (LUT), where each entry of the LUT specifies a particular preconfigured power splitting ratio. Accordingly, to indicate a preconfigured power splitting ratio, the IoT device 502 may indicate, in the receiver capability information, an index that maps to an entry in the LUT that specifies a preconfigured power splitting ratio. The use of an LUT enables the IoT device 502 to transmit less information (e.g., an index) relative to the power splitting ratio and preserve energy at the IoT device 502 and/or air interface resources for other use.

The receiver capability information may alternatively or additionally indicate a type of power ratio tuning capability, such as a discrete tuning capability or an analog tuning capability. To illustrate, the receiver capability information may indicate that the IoT device 502 includes an ability to tune a power splitter to one or more predefined, preconfigured, and/or discrete power splitting ratios, such as a first discrete power ratio corresponding to a 50/50 power split (e.g., 50% of the output power directed to the energy harvesting receiver and 50% of the output power directed to the communication receiver), a 70/30 power split (e.g., 70% of the output power directed to the energy harvesting receiver and 30% of the output power directed to the communication receiver), and/or an 80/20 power split (e.g., 80% of the output power directed to the energy harvesting receiver and 20% of the output power directed to the communication receiver). Alternatively or additionally, the receiver capability information may indicate that the IoT device 502 supports analog tuning of a power splitter (e.g., non-discrete and/or continuous tuning).

In some aspects, the receiver capability information may indicate a power splitter class associated with a power splitter included in the IoT device 502. The indicated power splitting class may be associated with one or more preconfigured and/or discrete power splitting ratios. Alternatively or additionally, the power splitting class may be associated with analog tuning of a power splitter. Accordingly, by explicitly indicating a power splitter class, the receiver capability information may implicitly indicate power splitting tuning capabilities.

Alternatively or additionally, the receiver capability information may indicate a power class associated with a power splitter included in the IoT device 502. To illustrate, the use of a power splitter may result in a power loss when a signal is split, such as a 3 decibel (dB), a 6 dB loss, or a 9 dB loss. In some aspects, a power class may be associated with a power loss such that specifying a power class in the receiver capability information may indicate a power loss at the IoT device 502.

The receiver capability information may indicate whether the IoT device 502 includes, and/or does not include, a low noise amplifier (e.g., in the energy harvesting receiver and/or in the communication receiver). To illustrate, a low noise amplifier may output an amplified signal with a gain that is based at least in part on a linearity of the lowpass amplifier. An accuracy of the output signal's gain (relative to an ideal gain) may vary based at least in part on a variety of factors, such as, by way of example and not of limitation, a center frequency of the input signal, a bandwidth of the input signal, and/or a power level of the input signal. In some aspect, the network node may configure resource scheduling based at least in part on mitigating interference at the IoT device 502 (e.g., to avoid interference in a communication signal). Accordingly, the receiver capability information may indicate that the IoT device 502 includes a low noise amplifier and, in some cases, may alternatively or additionally indicate a gain and/or linearity of the low noise amplifier.

In some aspects, the receiver capability information may indicate one or more demodulation formats supported by the IoT device 502. For example, the receiver capability information may indicate that the IoT device 502 supports envelope detection, an ASK format (e.g., OOK), and/or an IQ format (e.g., OFDM). In some cases, the receiver capability information may indicate that the IoT device 502 only supports a single demodulation format (e.g., only envelope detection). Alternatively or additionally, the receiver capability information may indicate a supported transmission direction for the demodulation format (e.g., downlink only for OFDM demodulation and/or uplink only for ASK modulation).

The IoT device 502 may indicate, in the receiver capability information, support for and/or the inclusion of a filter in the envelope harvesting receiver and/or the communication receiver, such as by including an optional field (e.g., a filter field) in the receiver capability information. Alternatively, or additionally, the IoT device 502 may indicate a filter type, such as a lowpass filter type and/or a bandpass filter type. In some aspects, the inclusion of a filter type field (e.g., a bit field) in the receiver capability information explicitly indicates that the IoT device 502 includes at least one filter, and the exclusion of the filter type field implicitly indicates that the IoT device 502 does not include any filters. In other aspects, the IoT device 502 may set the filter type field to a first value (e.g., “1”) to explicitly indicate that the IoT device 502 includes a filter in at least one receiver, and a second value (e.g., “0”) to explicitly indicate that the IoT device 502 does not include a filter. Based at least in part on indicating the inclusion of a filter, the IoT device 502 may indicate one or more filter characteristics associated with the filter type, such as a cut-off frequency associated with a lowpass filter, a bandwidth associated with a bandpass filter, and/or a center frequency associated with a bandpass filter. Other filter characteristics may include a transition band, a passband ripple, and/or a roll-off rate.

As shown by reference number 530, a network node 110 may transmit, and an IoT device 502 may receive, a signal that is based at least in part on the receiver capability information. For instance, the receiver capability information may indicate a time splitting capability and/or a time splitting receiver architecture, and the network node 110 may transmit a SWIPT that is based at least in part on alternating between transmission of an energy signal and a communication signal. That is, the network node 110 may alternate between transmission of an energy signal and transmission of a communication signal and/or transmit the energy signal and the communication signal based at least in part on TDM. In some aspects, the network node 110 may configure a first duration of the energy signal transmission and a second duration of the communication signal transmission based at least in part on one or more switching time periods indicated in the receiver capability information and/or one or more signal characteristics, such as the energy signal and the communication signal having the same or different carrier frequencies and/or being located in the same BWP and/or different BWPs. Alternatively, or additionally, the network node 110 may indicate a start of the communication signal, such as by transmitting a particular tone and/or preamble, to synchronize transmission of the communication signal and the energy signal with reception by the IoT device. That is, the network node 110 may indicate the start of the communication signal, and the IoT device may trigger switching which receiver path receives the signal based at least in part on the indication.

Based at least in part on the receiver capability information indicating a power splitting capability and/or a power splitting receiver architecture, the network node 110 may modify a transmission power level of the signal (e.g., increase a first transmission power level of an energy signal, decrease the first transmission power level of the energy signal, increase a second transmission power level of a communication signal, and/or decrease the second transmission power level of the communication signal). As one example, the receiver capability information may indicate a power split ratio, such as a discrete power split ratio and/or an analog power split ratio of how a receive signal is split between an energy harvesting receiver and a communication receiver. The network node 110 may calculate and/or estimate a signal-to-noise ratio (SNR) at the IoT device 502 using the power split ratio and subsequently adjust a power level of the signal (e.g., the energy signal and/or the communication signal) to increase an efficiency of power harvesting at the IoT device 502. To illustrate, the network node may transmit a signal with a transmitted power of P and, without power splitting, an IoT device may observe a signal-to-interference-plus-noise ratio (SINR) of X. In some aspects, the IoT device may include power splitting capabilities that perform a power splitting ratio of p. With a power splitting ratio of p, the IoT device may observe an SINR that is characterized as (1−p)X. Accordingly, and based at least in part on the characterization of SINR and/or the power splitting ratio, the network node 110 estimate signal-to-noise ratio (SNR) at the IoT device and adjust the transmission based on the estimated SNR, such as by adjusting a power level of the transmission. In some aspects, such as in a scenario in which the IoT device indicates that the power split ratio is adjustable, the network node 110 may instruct the IoT device to adjust the power split ratio. For example, the network node 110 may instruct the IoT device to adjust the power split ratio to provide more power to the communication receiver based at least in part on a data traffic priority and/or to provide more power to the energy harvesting receiver if an energy status of the IoT device satisfies a low power threshold.

The network node 110 may alternatively or additionally adjust a transmitted power level of the signal based at least in part on a power splitting class and/or a power class indicated by the receiver capability information. As one example, the network node 110 may determine the power splitting ratio based at least in part on a power splitter class and/or a power class indicated by the receiver capability information, calculate an estimated SNR at the IoT device 502, and adjust the power level of the signal as described above. As another example, the network node 110 may determine a power loss at the IoT device 502 based at least in part on the indicated power splitting class and/or the power class, and increase a transmitted power level to mitigate the power loss. Alternatively or additionally, the network node 110 may schedule air interface resources of one or more other transmissions to mitigate interference in the signal based at least in part on the receiver capability information indicating that the IoT device 502 includes a low noise amplifier.

In some aspects, the network node 110 may transmit the communication signal based at least in part on using a supported modulation format indicated by the receiver capability information. Alternatively, or additionally, the network node 110 may determine whether to FDM the energy signal and the communication signal based at least in part on whether the receiver capability information indicates that the IoT device 502 includes a filter. To illustrate, if the receiver capability information indicates that the IoT device 502 does not include a filter, the network node 110 may determine to not FDM the energy signal and the communication signal. That is, the IoT device 502 may not support FDM of the energy signal and the communication signal based at least in part on lacking a filter to separate the signals. As another example, the network node 110 may schedule air interface resources for one or more other UEs and/or other IoT devices based at least in part on a bandwidth of an indicated filter. For instance, the network node 110 may schedule the other IoT devices with air interface resources that are outside of the bandwidth of the filter associated with the IoT device 502. Alternatively, or additionally, the network node 110 may transmit an additional signal (e.g., a “helper” signal that improves envelope detection and/or reduces data recover errors) with the communication signal, and position the additional signal at a location (e.g., in frequency) that is within the bandwidth of the filter. In some aspects, the network node 110 may transmit the signal based at least in part on one or more characteristics of the filter and/or filter type, such as by transmitting the signal using a carrier frequency that is based at least in part on a passband and/or bandwidth of the filter and/or filter type.

By transmitting receiver capability information, an IoT device may indicate supported and unsupported features of the IoT device. A network node receiving the receiver capability information may subsequently modify a signal and/or transmission based at least in part on the receiver capability information as described above and below. The ability to modify the signal based at least in part on supported and/or unsupported features at the IoT device may result in fewer data recovery errors and/or increased a power harvesting efficiency at the IoT device.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with receiver capability information for an IoT device.

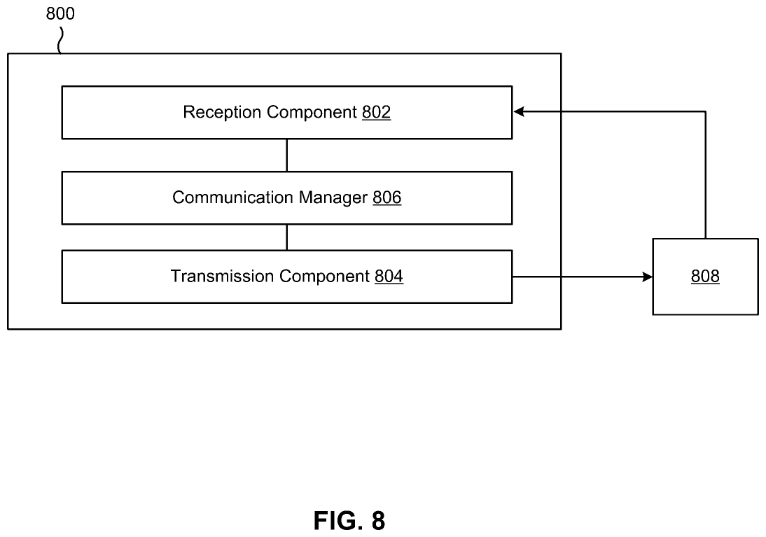

As shown in FIG. 6, in some aspects, process 600 may include transmitting an indication of receiver capability information associated with an IoT device (block 610). For example, the UE (e.g., using transmission component 804 and/or communication manager 806, depicted in FIG. 8) may transmit an indication of receiver capability information associated with an IoT device, as described above. In some aspects, the UE may be the IoT device.

As further shown in FIG. 6, in some aspects, process 600 may include receiving a signal that is based at least in part on the receiver capability information (block 620). For example, the UE (e.g., using reception component 802 and/or communication manager 806, depicted in FIG. 8) may receive a signal that is based at least in part on the receiver capability information, as described above.

Process 600 may include additional aspects, such as any single aspect or any combination of aspects described below and/or in connection with one or more other processes described elsewhere herein.

In a first aspect, the receiver capability information indicates a time splitting capability.

In a second aspect, the time splitting capability specifies at least one of a first switching time period associated with a first transition from receiving an energy signal to receiving a communication signal, or a second switching time period associated with a second transition from receiving the communication signal to receiving the energy signal.

In a third aspect, the time splitting capability specifies the first switching time period, and the first switching time period is based at least in part on at least one of the energy signal and the communication signal being located in a same bandwidth part, or the energy signal and the communication signal having a same carrier frequency.

In a fourth aspect, the time splitting capability specifies both the first switching time period and the second switching time period, and the first switching time period is different from the second switching time period.

In a fifth aspect, the second switching time period is shorter than the first switching time period.

In a sixth aspect, the time splitting capability specifies the first switching time period, and the first switching time period is based at least in part on at least one of the energy signal and the communication signal being located in different bandwidth parts, or the energy signal and the communication signal having different carrier frequencies.

In a seventh aspect, the first switching time period is based at least in part on a first hardware setting time that is associated with retuning receiver hardware to receive the communication signal.

In an eighth aspect, the time splitting capability specifies the second switching time period, the second switching time period is based at least in part on a second hardware settling time that is associated with retuning the receiver hardware to receive the energy signal, and the second switching time period is less than the first switching time period.

In a ninth aspect, the receiver capability information indicates a power splitting capability.

In a tenth aspect, the power splitting capability specifies a power split ratio associated with an energy harvesting receiver and a communication receiver.

In an eleventh aspect, the receiver capability information indicates, as the power split ratio, a preconfigured power split ratio.

In a twelfth aspect, the receiver capability information indicates the power split ratio based at least in part on a look-up table.

In a thirteenth aspect, the power splitting capability specifies a power splitter class associated with a power splitter at the IoT device.

In a fourteenth aspect, the power splitter class indicates a power loss associated with the power splitter.

In a fifteenth aspect, the power splitting capability specifies one or more supported power split ratios.

In a sixteenth aspect, the one or more supported power split ratios includes a predefined discrete power ratio.

In a seventeenth aspect, the one or more supported power split ratios specify support for an analog power ratio.

In an eighteenth aspect, the one or more supported power split ratios specify a preferred analog power ratio.

In a nineteenth aspect, the receiver capability information indicates a low noise amplifier.

In a twentieth aspect, the receiver capability information indicates a gain linearity associated with the low noise amplifier.

In a twenty-first aspect, the receiver capability information indicates one or more supported demodulation formats.

In a twenty-second aspect, the one or more supported demodulation formats include at least one of an ASK format, or an IQ format.

In a twenty-third aspect, the IQ format is an OFDM format.

In a twenty-fourth aspect, the receiver capability information indicates support for only envelope detection.

In a twenty-fifth aspect, the receiver capability information indicates a filter type.

In a twenty-sixth aspect, the filter type includes at least one of a bandpass filter, a lowpass filter.

In a twenty-seventh aspect, the receiver capability information indicates one or more filter characteristics associated with the filter type, and the one or more filter characteristics includes at least one of a cut-off frequency, a bandwidth, a center frequency, a transition band, a passband ripple, or a roll-off rate.

In a twenty-eighth aspect, transmitting the receiver capability information includes transmitting the receiver capability information via backscatter.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with receiver capability information for an IoT device.

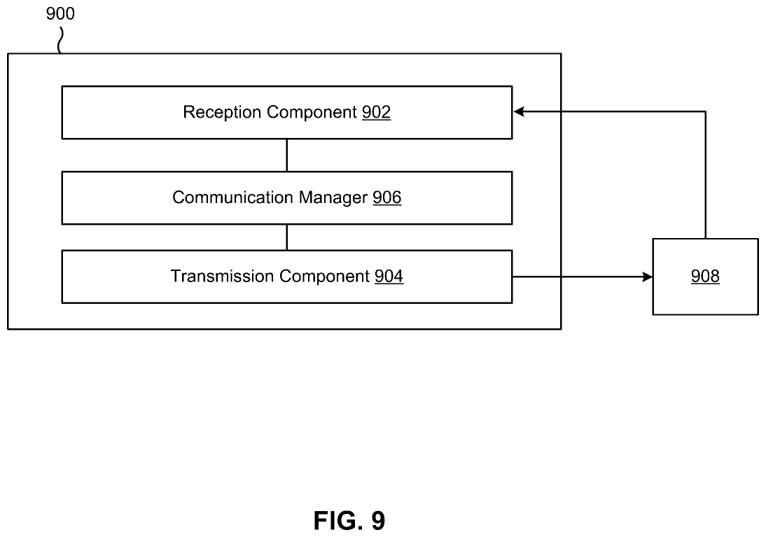

As shown in FIG. 7, in some aspects, process 700 may include receiving an indication of receiver capability information associated with an IoT device (block 710). For example, the network node (e.g., using reception component 902 and/or communication manager 906, depicted in FIG. 9) may receive an indication of receiver capability information associated with an IoT device, as described above.

As further shown in FIG. 7, in some aspects, process 700 may include transmitting a signal using a configuration that is based at least in part on the receiver capability information (block 720). For example, the network node (e.g., using transmission component 904 and/or communication manager 906, depicted in FIG. 9) may transmit a signal using a configuration that is based at least in part on the receiver capability information, as described above.

Process 700 may include additional aspects, such as any single aspect or any combination of aspects described below and/or in connection with one or more other processes described elsewhere herein.

In a first aspect, the configuration includes at least one of a power level that is based at least in part on the receiver capability information, a carrier frequency that is based at least in part on the receiver capability information, or a modulation format that is based at least in part on the receiver capability information.

In a second aspect, the receiver capability information indicates a time splitting capability, and transmitting the signal using the configuration that is based at least in part on the receiver capability information includes alternating between transmission of an energy signal and transmission of a communication signal based at least in part on the time splitting capability.

In a third aspect, the time splitting capability specifies at least one of a first switching time period associated with a first transition from receiving the energy signal to receiving the communication signal, or a second switching time period associated with a second transition from receiving the communication signal to receiving the energy signal.

In a fourth aspect, the time splitting capability specifies the first switching time period, and the first switching time period is based at least in part on at least one of the energy signal and the communication signal being located in a same bandwidth part, or the energy signal and the communication signal having a same carrier frequency.

In a fifth aspect, the time splitting capability specifies both the first switching time period and the second switching time period, and the first switching time period is different from the second switching time period.

In a sixth aspect, the second switching time period is less than the first switching time period.

In a seventh aspect, the time splitting capability specifies the first switching time period, and the first switching time period is based at least in part on at least one of the energy signal and the communication signal being located in different bandwidth parts, or the energy signal and the communication signal having different carrier frequencies.

In an eighth aspect, the time splitting capability specifies the second switching time period, and the second switching time period is less than the first switching time period.

In a ninth aspect, the receiver capability information indicates a power splitting capability, and transmitting the signal using the configuration that is based at least in part on the receiver capability information includes transmitting the signal using a power level that is based at least in part on the power splitting capability.

In a tenth aspect, the power splitting capability specifies a power split ratio associated with an energy harvesting receiver and a communication receiver.

In an eleventh aspect, the receiver capability information indicates, as the power split ratio, a preconfigured power split ratio.

In a twelfth aspect, the receiver capability information indicates the power split ratio based at least in part on a look-up table.

In a thirteenth aspect, the power splitting capability specifies a power splitter class associated with a power splitter at the IoT device.

In a fourteenth aspect, the power splitter class indicates a power loss associated with the power splitter, and the power level is configured to mitigate the power loss.

In a fifteenth aspect, the power splitting capability specifies one or more supported power split ratios.

In a sixteenth aspect, the one or more supported power split ratios includes a predefined discrete power ratio.

In a seventeenth aspect, the one or more supported power split ratios specify support for an analog power ratio.

In an eighteenth aspect, the one or more supported power split ratios specify a preferred analog power ratio.

In a nineteenth aspect, the receiver capability information indicates a low noise amplifier, and transmitting the signal using the configuration that is based at least in part on the receiver capability information includes transmitting the signal using an air interface resource configured to mitigate interference at the IoT device.

In a twentieth aspect, the receiver capability information indicates a gain linearity associated with the low noise amplifier.

In a twenty-first aspect, the receiver capability information indicates one or more supported demodulation formats, and transmitting the signal using the configuration that is based at least in part on the receiver capability information includes transmitting the signal using a modulation format that is complementary to a supported demodulation format indicated in the one or more supported demodulation formats.

In a twenty-second aspect, the one or more supported demodulation formats include at least one of an ASK format, or an IQ format.

In a twenty-third aspect, the IQ format is an OFDM format.

In a twenty-fourth aspect, the receiver capability information indicates support for only envelope detection, and transmitting the signal using the configuration that is based at least in part on the receiver capability information includes transmitting the signal using a modulation format that is complementary to envelope detection.

In a twenty-fifth aspect, the receiver capability information indicates a filter type, and transmitting the signal using the configuration that is based at least in part on the receiver capability information includes transmitting the signal using a carrier frequency that is based at least in part on a passband of the filter type.

In a twenty-sixth aspect, the filter type includes at least one of a bandpass filter, or a lowpass filter.

In a twenty-seventh aspect, the receiver capability information indicates one or more filter characteristics associated with the filter type, the one or more filter characteristics including at least one of a cut-off frequency, a bandwidth, a center frequency, a transition band, a passband ripple, or a roll-off rate.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the UE is an IoT device. Alternatively, or additionally, in some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 4A-7. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit an indication of receiver capability information associated with an IoT device. The reception component 802 may receive a signal that is based at least in part on the receiver capability information.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4A-7. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive an indication of receiver capability information associated with an IoT device. The transmission component 904 may transmit a signal using a configuration that is based at least in part on the receiver capability information. In some aspects, the communication manager 906 may configure the signal based at least in part on the receiver capability information.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting an indication of receiver capability information associated with an Internet-of-Things (IoT) device; and receiving a signal that is based at least in part on the receiver capability information.

Aspect 2: The method of Aspect 1, wherein the receiver capability information indicates a time splitting capability.

Aspect 3: The method of Aspect 2, wherein the time splitting capability specifies at least one of: a first switching time period associated with a first transition from receiving an energy signal to receiving a communication signal, or a second switching time period associated with a second transition from receiving the communication signal to receiving the energy signal.

Aspect 4: The method of Aspect 3, wherein the time splitting capability specifies the first switching time period, and wherein the first switching time period is based at least in part on at least one of: the energy signal and the communication signal being located in a same bandwidth part, or the energy signal and the communication signal having a same carrier frequency.

Aspect 5: The method of Aspect 3, wherein the time splitting capability specifies both the first switching time period and the second switching time period, and wherein the first switching time period is different from the second switching time period.

Aspect 6: The method of Aspect 5, wherein the second switching time period is shorter than the first switching time period.

Aspect 7: The method of Aspect 3, wherein the time splitting capability specifies the first switching time period, and wherein the first switching time period is based at least in part on at least one of: the energy signal and the communication signal being located in different bandwidth parts, or the energy signal and the communication signal having different carrier frequencies.

Aspect 8: The method of Aspect 7, wherein the first switching time period is based at least in part on a first hardware setting time that is associated with retuning receiver hardware to receive the communication signal.

Aspect 9: The method of Aspect 8, wherein the time splitting capability specifies the second switching time period, wherein the second switching time period is based at least in part on a second hardware settling time that is associated with retuning the receiver hardware to receive the energy signal, and wherein the second switching time period is less than the first switching time period.

Aspect 10: The method of any of Aspects 1-9, wherein the receiver capability information indicates a power splitting capability.

Aspect 11: The method of Aspect 10, wherein the power splitting capability specifies a power split ratio associated with an energy harvesting receiver and a communication receiver.

Aspect 12: The method of Aspect 11, wherein the receiver capability information indicates, as the power split ratio, a preconfigured power split ratio.

Aspect 13: The method of Aspect 11, wherein the receiver capability information indicates the power split ratio based at least in part on a look-up table.

Aspect 14: The method of Aspect 11, wherein the power splitting capability specifies a power splitter class associated with a power splitter at the IoT device.

Aspect 15: The method of Aspect 14, wherein the power splitter class indicates a power loss associated with the power splitter.

Aspect 16: The method of Aspect 11, wherein the power splitting capability specifies one or more supported power split ratios.

Aspect 17: The method of Aspect 16, wherein the one or more supported power split ratios includes a predefined discrete power ratio.

Aspect 18: The method of Aspect 16, wherein the one or more supported power split ratios specify support for an analog power ratio.

Aspect 19: The method of Aspect 16, wherein the one or more supported power split ratios specify a preferred analog power ratio.

Aspect 20: The method of any of Aspects 1-19, wherein the receiver capability information indicates a low noise amplifier.

Aspect 21: The method of Aspect 20, wherein the receiver capability information indicates a gain linearity associated with the low noise amplifier.

Aspect 22: The method of any of Aspects 1-21, wherein the receiver capability information indicates one or more supported demodulation formats.

Aspect 23: The method of Aspect 22, wherein the one or more supported demodulation formats include at least one of: an amplitude shift keying (ASK) format, or an in-phase/quadrature-phase (IQ) format.

Aspect 24: The method of Aspect 23, wherein the IQ format is an orthogonal frequency division multiplexing (OFDM) format.

Aspect 25: The method of any of Aspects 1-24, wherein the receiver capability information indicates support for only envelope detection.

Aspect 26: The method of any of Aspects 1-25, wherein the receiver capability information indicates a filter type.

Aspect 27: The method of Aspect 26, wherein the filter type includes at least one of: a bandpass filter, a lowpass filter.

Aspect 28: The method of Aspect 26 or Aspect 27, wherein the receiver capability information indicates one or more filter characteristics associated with the filter type, the one or more filter characteristics including at least one of: a cut-off frequency, a bandwidth, a center frequency, a transition band, a passband ripple, or a roll-off rate.

Aspect 29: The method of any of Aspects 1-28, wherein transmitting the receiver capability information includes: transmitting the receiver capability information via backscatter.

Aspect 30: A method of wireless communication performed by a network node, comprising: receiving an indication of receiver capability information associated with an Internet-of-Things (IoT) device; and transmitting a signal using a configuration that is based at least in part on the receiver capability information.

Aspect 31: The method of Aspect 30, wherein the configuration includes at least one of: a power level that is based at least in part on the receiver capability information, a carrier frequency that is based at least in part on the receiver capability information, or a modulation format that is based at least in part on the receiver capability information.

Aspect 32: The method of any of Aspects 30-31, wherein the receiver capability information indicates a time splitting capability, and wherein transmitting the radio signal using the configuration that is based at least in part on the receiver capability information comprises: alternating between transmission of an energy signal and transmission of a communication signal based at least in part on the time splitting capability.

Aspect 33: The method of Aspect 32, wherein the time splitting capability specifies at least one of: a first switching time period associated with a first transition from receiving the energy signal to receiving the communication signal, or a second switching time period associated with a second transition from receiving the communication signal to receiving the energy signal.

Aspect 34: The method of Aspect 33, wherein the time splitting capability specifies the first switching time period, and wherein the first switching time period is based at least in part on at least one of: the energy signal and the communication signal being located in a same bandwidth part, or the energy signal and the communication signal having a same carrier frequency.

Aspect 35: The method of Aspect 33, wherein the time splitting capability specifies both the first switching time period and the second switching time period, and wherein the first switching time period is different from the second switching time period.

Aspect 36: The method of Aspect 35, wherein the second switching time period is less than the first switching time period.

Aspect 37: The method of Aspect 33, wherein the time splitting capability specifies the first switching time period, and wherein the first switching time period is based at least in part on at least one of: the energy signal and the communication signal being located in different bandwidth parts, or the energy signal and the communication signal having different carrier frequencies.

Aspect 38: The method of Aspect 37, wherein the time splitting capability specifies the second switching time period, and wherein the second switching time period is less than the first switching time period.

Aspect 39: The method of any of Aspects 30-38, wherein the receiver capability information indicates a power splitting capability, and wherein transmitting the signal using the configuration that is based at least in part on the receiver capability information comprises: transmitting the signal using a power level that is based at least in part on the power splitting capability.

Aspect 40: The method of Aspect 39, wherein the power splitting capability specifies a power split ratio associated with an energy harvesting receiver and a communication receiver.

Aspect 41: The method of Aspect 40, wherein the receiver capability information indicates, as the power split ratio, a preconfigured power split ratio.

Aspect 42: The method of Aspect 40, wherein the receiver capability information indicates the power split ratio based at least in part on a look-up table.

Aspect 43: The method of Aspect 40, wherein the power splitting capability specifies a power splitter class associated with a power splitter at the IoT device.

Aspect 44: The method of Aspect 43, wherein the power splitter class indicates a power loss associated with the power splitter, and wherein the power level is configured to mitigate the power loss.

Aspect 45: The method of Aspect 40, wherein the power splitting capability specifies one or more supported power split ratios.

Aspect 46: The method of Aspect 45, wherein the one or more supported power split ratios includes a predefined discrete power ratio.

Aspect 47: The method of Aspect 45, wherein the one or more supported power split ratios specify support for an analog power ratio.

Aspect 48: The method of Aspect 45, wherein the one or more supported power split ratios specify a preferred analog power ratio.

Aspect 49: The method of any of Aspects 30-48, wherein the receiver capability information indicates a low noise amplifier, and wherein transmitting the signal using the configuration that is based at least in part on the receiver capability information comprises: transmitting the signal using an air interface resource configured to mitigate interference at the IoT device.

Aspect 50: The method of Aspect 49, wherein the receiver capability information indicates a gain linearity associated with the low noise amplifier.

Aspect 51: The method of any of Aspects 30-50, wherein the receiver capability information indicates one or more supported demodulation formats, and wherein transmitting the signal using the configuration that is based at least in part on the receiver capability information comprises: transmitting the signal using a modulation format that is complementary to a supported demodulation format indicated in the one or more supported demodulation formats.

Aspect 52: The method of Aspect 51, wherein the one or more supported demodulation formats include at least one of: an amplitude shift keying (ASK) format, or an in-phase/quadrature-phase (IQ) format.

Aspect 53: The method of Aspect 52, wherein the IQ format is an orthogonal frequency division multiplexing (OFDM) format.

Aspect 54: The method of any of Aspects 30-53, wherein the receiver capability information indicates support for only envelope detection, and wherein transmitting the signal using the configuration that is based at least in part on the receiver capability information comprises: transmitting the signal using a modulation format that is complementary to envelope detection.

Aspect 55: The method of any of Aspects 30-54, wherein the receiver capability information indicates a filter type, and wherein transmitting the signal using the configuration that is based at least in part on the receiver capability information comprises: transmitting the signal using a carrier frequency that is based at least in part on a passband of the filter type.

Aspect 56: The method of Aspect 55, wherein the filter type includes at least one of: a bandpass filter, or a lowpass filter.

Aspect 57: The method of Aspect 55, wherein the receiver capability information indicates one or more filter characteristics associated with the filter type, the one or more filter characteristics including at least one of: a cut-off frequency, a bandwidth, a center frequency, a transition band, a passband ripple, or a roll-off rate.

Aspect 58: An apparatus for wireless communication at a device, comprising a processor; memory coupled with the processor; and instructions stored in the memory and executable by the processor to cause the apparatus to perform the method of one or more of Aspects 1-29.

Aspect 59: An apparatus for wireless communication at a device, comprising a processor; memory coupled with the processor; and instructions stored in the memory and executable by the processor to cause the apparatus to perform the method of one or more of Aspects 30-57.

Aspect 60: A device for wireless communication, comprising a memory and one or more processors coupled to the memory, the one or more processors configured to perform the method of one or more of Aspects 1-29.

Aspect 61: A device for wireless communication, comprising a memory and one or more processors coupled to the memory, the one or more processors configured to perform the method of one or more of Aspects 30-57.

Aspect 62: An apparatus for wireless communication, comprising at least one means for performing the method of one or more of Aspects 1-29.

Aspect 63: An apparatus for wireless communication, comprising at least one means for performing the method of one or more of Aspects 30-57.

Aspect 64: A non-transitory computer-readable medium storing code for wireless communication, the code comprising instructions executable by a processor to perform the method of one or more of Aspects 1-29.

Aspect 65: A non-transitory computer-readable medium storing code for wireless communication, the code comprising instructions executable by a processor to perform the method of one or more of Aspects 30-57.

Aspect 66: A non-transitory computer-readable medium storing a set of instructions for wireless communication, the set of instructions comprising one or more instructions that, when executed by one or more processors of a device, cause the device to perform the method of one or more of Aspects 1-29.

Aspect 67: A non-transitory computer-readable medium storing a set of instructions for wireless communication, the set of instructions comprising one or more instructions that, when executed by one or more processors of a device, cause the device to perform the method of one or more of Aspects 30-57.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
transmit an indication of receiver capability information associated with an Internet-of-Things (IoT) device; and
receive a signal that is based at least in part on the receiver capability information.

2. The apparatus of claim 1, wherein the receiver capability information indicates a time splitting capability.

3. The apparatus of claim 2, wherein the time splitting capability specifies at least one of:
a first switching time period associated with a first transition from receiving an energy signal to receiving a communication signal, or
a second switching time period associated with a second transition from receiving the communication signal to receiving the energy signal.

4. The apparatus of claim 3, wherein the time splitting capability specifies the first switching time period, and
wherein the first switching time period is based at least in part on at least one of:
the energy signal and the communication signal being located in a same bandwidth part, or
the energy signal and the communication signal having a same carrier frequency.

5. The apparatus of claim 3, wherein the time splitting capability specifies the first switching time period, and
wherein the first switching time period is based at least in part on at least one of:
the energy signal and the communication signal being located in different bandwidth parts, or
the energy signal and the communication signal having different carrier frequencies.

6. The apparatus of claim 1, wherein the receiver capability information indicates a power splitting capability.

7. The apparatus of claim 6, wherein the power splitting capability specifies a power split ratio associated with an energy harvesting receiver and a communication receiver.

8. The apparatus of claim 7, wherein the receiver capability information indicates the power split ratio based at least in part on a look-up table.

9. The apparatus of claim 1, wherein the receiver capability information indicates a low noise amplifier.

10. The apparatus of claim 1, wherein the receiver capability information indicates one or more supported demodulation formats.

11. The apparatus of claim 1, wherein the receiver capability information indicates support for only envelope detection.

12. The apparatus of claim 1, wherein the receiver capability information indicates a filter type.

13. An apparatus for wireless communication at a network node, comprising:
a memory; and
one or more processors, coupled to the memory, configured to:
receive an indication of receiver capability information associated with an Internet-of-Things (IoT) device; and
transmit a signal using a configuration that is based at least in part on the receiver capability information.

14. The apparatus of claim 13, wherein the configuration includes at least one of:
a power level that is based at least in part on the receiver capability information,
a carrier frequency that is based at least in part on the receiver capability information, or
a modulation format that is based at least in part on the receiver capability information.

15. The apparatus of claim 13, wherein the receiver capability information indicates a time splitting capability, and
wherein the one or more processors, to transmit the signal using the configuration that is based at least in part on the receiver capability information, are configured to:
alternate between transmission of an energy signal and transmission of a communication signal based at least in part on the time splitting capability.

16. The apparatus of claim 15, wherein the time splitting capability specifies at least one of:
a first switching time period associated with a first transition from receiving the energy signal to receiving the communication signal, or
a second switching time period associated with a second transition from receiving the communication signal to receiving the energy signal.

17. The apparatus of claim 16, wherein the time splitting capability specifies the first switching time period, and
wherein the first switching time period is based at least in part on at least one of:
the energy signal and the communication signal being located in a same bandwidth part, or
the energy signal and the communication signal having a same carrier frequency.

18. The apparatus of claim 16, wherein the time splitting capability specifies the first switching time period, and
wherein the first switching time period is based at least in part on at least one of:
the energy signal and the communication signal being located in different bandwidth parts, or
the energy signal and the communication signal having different carrier frequencies.

19. The apparatus of claim 13, wherein the receiver capability information indicates a power splitting capability, and
wherein the one or more processors, to transmit the signal using the configuration that is based at least in part on the receiver capability information, are configured to:
transmit the signal using a power level that is based at least in part on the power splitting capability.

20. The apparatus of claim 13, wherein the receiver capability information indicates a low noise amplifier, and
wherein the one or more processors, to transmit the signal using the configuration that is based at least in part on the receiver capability information, are configured to:
transmit the signal using an air interface resource configured to mitigate interference at the IoT device.

21-30. (canceled)
